(19) United States
(12) Patent Application Publication
(10) Pub. No.: US 2024/0416373 A1
(43) Pub. Date: Dec. 19, 2024

(54) PRESSURE WASHER

(71) Applicant: Andreas Stihl AG & Co. KG, Waiblingen (DE)

(72) Inventors: Klaus Kaupp, Waiblingen (DE); Matthias Sauter, Stuttgart (DE); Anna Mirl, Esslingen (DE)

(21) Appl. No.: 18/747,745

(22) Filed: Jun. 19, 2024

(30) Foreign Application Priority Data
Jun. 19, 2023 (EP) 23180026.9

(51) Int. Cl. B05B 9/04

(52) U.S. Cl. CPC B05B 9/0426

(57) ABSTRACT

A pressure washer includes a connection for a liquid source and a main line, through which a liquid is conveyable from the connection to a discharge opening of the main line via a high-pressure pump. The main line has a suction chamber between the connection and the pump. The main line has a pressure chamber between the pump and the discharge opening. The main line has an outlet through which the liquid from the main line can flow into the return line. The start valve closes so that no liquid can flow through the return line from the pressure chamber into the suction chamber if a volume flow through the start valve corresponds at least to a starting volume threshold value. The start valve has a seat arranged at the outlet opening and configured to be closed by a movement of the valve member in the flow direction.

### CROSS-REFERENCE TO RELATED APPLICATIONS

This application claims priority of European patent application no. 23180026.9, filed Jun. 19, 2023, the entire content of which is incorporated herein by reference.

### BACKGROUND

It is known that a return line with a start valve can be provided between the pressure chamber and the suction chamber. The pressure washer is configured such that the start valve closes in such a way that no liquid can flow from the pressure chamber into the suction chamber through the return line if the volume flow through the start valve corresponds at least to a starting volume threshold value. However, below the starting volume threshold value, liquid can flow through the return line. This makes it easier to start the high-pressure pump or the motor of the high-pressure pump. The high-pressure pump then does not need to operate against a high pressure in the pressure chamber, especially when the main line valve is closed. In the start-up phase, the high-pressure pump can pump liquid in the circuit from the pressure chamber into the suction chamber via the return line without having to operate at an initially low torque or low rotational speed against a high counterpressure. This allows the pump to reach a rotational speed at which it can then provide sufficient torque at the corresponding counterpressure, until the starting volume threshold value is reached and the start valve is closed. Only after the high-pressure pump or the motor has reached this rotational speed does it have to operate against a higher pressure in the pressure chamber. In the case of pressure washers from the prior art, the motor, in spite of the start valve, may run hot and stall during a start-up attempt.

### SUMMARY

It is an object of the disclosure to develop a pressure washer of the type in question in such a way that reliable starting-up of the motor of the high-pressure pump is ensured.

This object is, for example, achieved by a pressure washer including: a connection for a liquid source; a high-pressure pump; a main line, through which a liquid is conveyable from the connection to a spray discharge opening of the main line via the high-pressure pump; the main line having a suction chamber between the connection and the high-pressure pump; the main line having a pressure chamber between the high-pressure pump and the spray discharge opening; the pressure chamber being fluidically connected to the suction chamber via a return line; the main line having an outlet opening through which the liquid from the main line is configured to flow into the return line; a start valve; the pressure washer being configured such that the start valve closes so that no liquid can flow through the return line from the pressure chamber into the suction chamber if a volume flow through the start valve corresponds at least to a starting volume threshold value; the start valve having a valve member; wherein the liquid conveyed through the main line from the connection to the spray discharge opening via the high-pressure pump impinges on the start valve in the main line in a flow direction; the start valve being arranged in the main line downstream of the high-pressure pump; and, the start valve having a valve seat arranged at the outlet opening of the main line and configured to be closed by a movement of the valve member in the flow direction.

The disclosure is based on the finding that the time, or the rotational speed value, at which the start valve closes because the starting volume threshold value has been reached, is not always reliably reproducible, with substantially unchanged operating conditions, in the pressure washers which are known to date. In the cases in which the motor runs hot and stalls, the start valve is closed before the motor has reached a rotational speed within its operating range.

The disclosure is furthermore based on the finding that, in the case of the pressure washers from the prior art, the volume flow in the return line also depends on external parameters, such as the nozzle cross section at the spray discharge opening and other throttling in the main line. The return line is a branch line of the main line between the high-pressure pump and the spray discharge opening. The volume flow is divided at this branch. The proportion of the volume flow that is branched off into the return line before the branching depends on external parameters. This explains why, under otherwise consistent operating conditions, the closing and opening times of the start valve located in the return line, or the rotational speed values of the motor, at which the start valve opens or closes, vary.

In order to solve the problem identified within the scope of the disclosure, the disclosure makes provision to arrange the start valve in the main line downstream of the high-pressure pump. The arrangement of the start valve in the main line causes the full, undivided volume flow of liquid to impinge upon the start valve. Since no proportion of the volume flow has been branched off from the main line before the volume flow impinges upon the start valve, the start valve reliably closes and opens. The parameter that determines the closing and opening of the start valve can be reliably reproduced according to the disclosure. Since the volume flow impinging upon the start valve is undivided, external parameters that have an influence on how large the branched-off proportion of the volume flow into the return line is, are unimportant. In particular, the volume flow at the start valve is independent of the cross section of the nozzle used at the spray discharge opening. Therefore, the times or the rotational speeds of the motor, at which the start valve opens and closes, can also be reproduced. This has the result that even the pressure against which the high-pressure pump has to operate during starting up is reproducible. The start valve can operate reliably and reproducibly by the start valve being arranged in the main line. Accordingly, the start valve reliably closes only when the motor, when starting up, has reached a rotational speed within its working rotational speed range.

The start valve is advantageously arranged in the main line upstream of the return line. This ensures that no proportion of the volume flow is branched off into the return line before the volume flow impinges upon the start valve. This results in reproducible conditions for the start valve. The full volume flow is available for switching the start valve.

In particular, the start valve is arranged outside the return line. This prevents a proportion of the volume flow from branching off through the main line into the return line before impinging upon the start valve.

In particular, the main line in the region between the high-pressure pump and the spray discharge opening is that line of the pressure washer in which the liquid travels the shortest distance from the high-pressure pump to the spray discharge opening. Branchings off from the main line, in which the liquid possibly flows forwards and back, are not included in the main line. The pressure washer has a main flow path. Along the main flow path, the liquid flows from the connection for the liquid source to the spray discharge opening. The main flow path runs along the main line. The start valve is arranged in particular in the main flow path.

The pressure washer is expediently configured such that, during operation of the pressure washer, the liquid flows with a volume flow through the start valve below the starting volume threshold value without the possibility of branching off from the high-pressure pump to the start valve in the main line. In particular, the pressure washer is configured such that, during operation of the pressure washer, the liquid flows independently of the volume flow through the start valve without the possibility of branching off from the high-pressure pump to the start valve in the main line.

Expediently, the start valve is configured such that it permits the throughflow of liquid from the pressure chamber into the return line at a volume flow through the start valve below the starting volume threshold value. This makes it easier to start the high-pressure pump or the motor of the high-pressure pump. The high-pressure pump or the motor does not have to work against a high pressure in the pressure chamber during the starting up. This is especially advantageous when the main line valve is closed.

Expediently, the start valve is configured such that it prevents the throughflow of liquid from the pressure chamber into the return line if the volume flow through the start valve corresponds at least to the starting volume threshold value. This allows sufficient pressure to build up in the pressure chamber after the starting volume threshold value has been reached. Cleaning with the pressure washer is then possible. Owing to the fact that the start valve prevents the throughflow of liquid from the pressure chamber into the return line only after the starting volume threshold value has been reached, the motor of the high-pressure pump can initially reach a sufficient rotational speed at which it can generate sufficient torque to operate against a corresponding pressure in the pressure chamber. This prevents failures of the motor and the high-pressure pump during the starting up. It is also prevented that the motor does not reach the sufficient rotational speed at all because the pressure against which the pump or the motor has to operate is too high.

In particular, the start valve located in the main line divides the pressure chamber of the main line into a pump section and a spray discharge section. The pump section is arranged between the high-pressure pump and the start valve. The spray discharge section is arranged between the start valve and the spray discharge opening. Advantageously, the start valve is configured such that it permits a direct throughflow of liquid from the pump section into the spray discharge section at a volume flow through the start valve, which corresponds at least to the starting volume threshold value. In particular, this direct throughflow from the pump section into the spray discharge section takes place without the detour via the return line. In particular, the transfer of the liquid from the pump section to the spray discharge section takes place without branching off a proportion of the volume flow, for example into the return line. As a result, the pressure generated by the high-pressure pump in the pressure chamber is independent of the proportion of the volume flow that is branched off into a return line. This contributes to reproducible operating conditions.

The start valve has an inlet. The inlet is connected in particular to the main line. The inlet is expediently connected directly to the main line. The inlet is connected in particular to the pump section of the pressure chamber of the main line. The start valve has a return outlet. The return outlet is connected in particular to the return line. The start valve expediently has a main line outlet. The main line outlet is connected in particular to the main line. In particular, the main line outlet is connected to the spray discharge section of the pressure chamber of the main line. The pressure washer is expediently configured such that the start valve closes the return outlet when the volume flow through the start valve corresponds at least to the starting volume threshold value.

The start valve has a valve member. The liquid conveyed by the high-pressure pump from the connection to the spray discharge opening through the main line impinges upon the start valve in the main line in a flow direction. In particular, the pressure washer is configured in such a way that the flow direction runs parallel to the main line at the point of impact of the liquid on the start valve.

In an embodiment of the disclosure, the pressure washer comprises a stop element for the valve member. Expediently, the valve member is preloaded in the direction of the stop element. The pressure washer is configured such that the valve member bears against the stop element when the volume flow through the start valve falls below a resting volume threshold value. This causes the valve member to be pressed against the stop element at a defined pressure. In particular, when a spring is used for preloading the valve member, defined force ratios prevail when the valve member bears against the stop element. In particular, the valve member bears against the stop element in a state of the valve member in which it is not loaded by the liquid. Owing to the stop element and the bearing of the valve member against the stop element, the pressure that has to be applied by the volume flow for movement of the valve member away from the stop element is clearly defined. This contributes to reproducible working conditions of the pressure washer.

The valve member expediently has an inflow surface. The inflow surface is advantageously aligned transversely, in particular perpendicularly to the flow direction. This results in a particularly good transmission of force or pressure by the liquid to the valve member. The inflow surface of the valve member is expediently arranged completely in the main line.

In particular, the valve member is movable in one movement direction. The movement direction is expediently in the direction of the flow direction. This also contributes to good pressure transmission from the liquid to the valve member. It may be provided that the movement direction of the valve member runs in the direction of an axial direction of the start valve. In particular, the axial direction of the start valve runs in the longitudinal direction of the start valve.

Advantageously, the valve member is arranged completely in the main line, in particular completely outside the return line.

The valve member has a peripheral surface pointing to an inner wall of the start valve. Expediently, a gap forming the minimum free cross-sectional area is formed between the peripheral surface and the inner wall. The minimum free cross-sectional area is the smallest area through which the volume flow flows in the start valve. The minimum free cross-sectional area does not necessarily have to run perpendicularly to the main line. However, it is perpendicular to the flow direction of the volume flow through the start valve present at the location of the minimum free cross-sectional area.

In an embodiment of the disclosure, the start valve has an inlet surface. The inlet surface is oriented perpendicularly to the flow direction. The liquid enters the start valve through the inlet surface. Expediently, the valve member permits the minimum free cross-sectional area through the main line below the resting volume threshold value, in particular in the state in which it is not loaded by the liquid. Expediently, the minimum free cross-sectional area is at least 5%, preferably at least 10% of the inlet surface. As a result, a throughflow of liquid through the start valve is also possible below the resting volume threshold value, in particular in the state in which it is not loaded by the liquid. The fact that the start valve does not close the main line below the resting volume threshold value makes it easy for the valve member to move out of its inoperative position. When the high-pressure pump or the motor starts up or after it has started up, the valve member can then be easily pushed away out of its inoperative position, in particular away from the stop element. This prevents the valve member from sticking or adhering.

Preferably, the minimum free cross-sectional area is not more than 70%, in particular not more than 60% of the inlet surface. This allows enough pressure from the liquid to act on the valve member. The valve member can easily move out of its inoperative position.

In an embodiment of the disclosure, the peripheral surface has a plurality of cutouts distributed over the circumference. The peripheral surface has a smallest gap distance, as measured perpendicularly to the inner wall of the start valve. The cutouts have a largest cutout distance from the inner wall, as measured perpendicularly to the inner wall of the start valve. The largest cutout distance is expediently at least twice the smallest gap distance. The introduction of cutouts enables the valve member to be easily adapted to different operating conditions. In terms of manufacturing, all that is needed for this purpose is to introduce different numbers of cutouts. In particular, the largest cutout distance between the cutouts is at most 20 times the smallest gap distance.

The valve member is movable in the direction of flow in order to close the valve seat of the start valve. The valve seat is arranged in particular at the inlet of the return line.

### BRIEF DESCRIPTION OF DRAWINGS

The invention will now be described with reference to the drawings wherein:

FIG. 1 shows a schematic illustration of a pressure washer in an operating state in which the high-pressure pump does not convey any liquid and the return line is not closed by the start valve;

FIG. 2 shows a schematic illustration of a pressure washer from FIG. 1 in an operating state in which the high-pressure pump conveys liquid in such a way that the volume flow of the liquid conveyed by the start valve lies below the starting volume threshold value;

FIG. 3 shows a schematic illustration of the pressure washer from FIG. 1 in an operating state in which the high-pressure pump conveys liquid with a volume flow through the start valve above the starting volume threshold value such that the start valve closes the return line;

FIG. 4 shows a semi-sectioned, schematic illustration of the start valve from FIGS. 1 to 3; and,

FIG. 5 shows a schematic diagram showing the dependency of the available and required torque of the motor for driving the high-pressure pump on the rotational speed.

### DETAILED DESCRIPTION

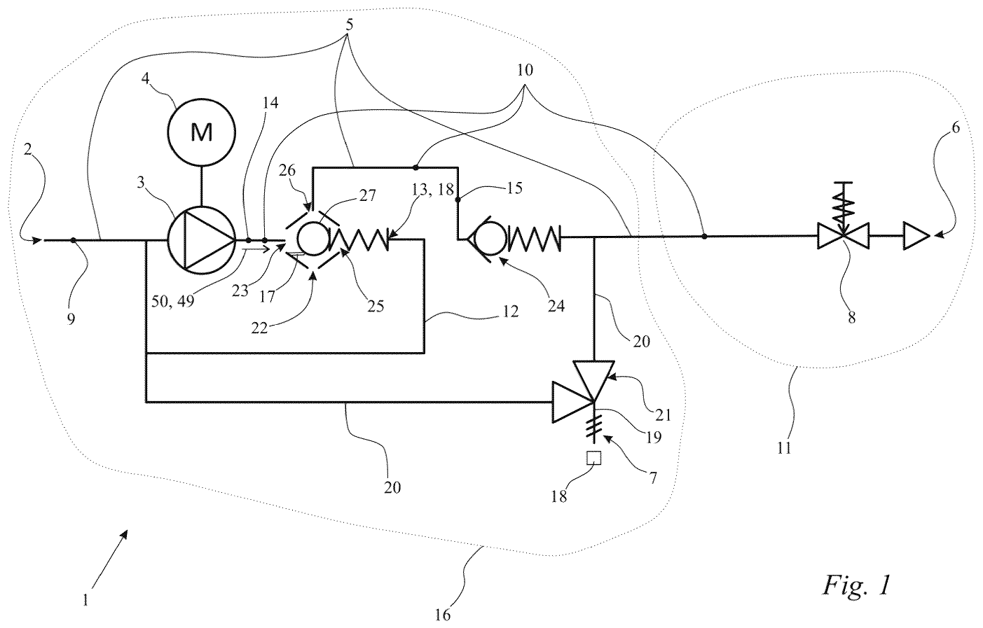

FIG. 1 shows a pressure washer 1 in a schematic illustration. The pressure washer 1 comprises a pump unit 16 and a sprayer unit 11. The pump unit 16 and the sprayer unit 11 are fluidically connected to each other via a main line 5. In the embodiment, the sprayer unit 11 comprises a gun, not illustrated. However, it may also be provided that the sprayer unit comprises a gun and a lance.

The pressure washer 1 comprises a connection 2 for a liquid source. In the embodiment, the liquid source is an external liquid source. For example, the external liquid source may be a domestic water supply system. However, it may also be provided that the liquid source is an integral part of the pressure washer.

The pressure washer 1 comprises a spray discharge opening 6. The pressure washer 1 comprises the main line 5. The main line 5 of the pressure washer 1 fluidically connects the connection 2 to the spray discharge opening 6. The connection 2 is arranged on the pump unit 16. The spray discharge opening 6 is arranged on the sprayer unit 11. In the embodiment, the spray discharge opening 6 is arranged on the sprayer unit 11 which is in the form of a gun. However, it may also be provided that the spray discharge opening 6 is arranged on an interchangeable lance of the sprayer unit 11.

The pressure washer 1 comprises a high-pressure pump 3. Via the high-pressure pump 3, liquid can be conveyed from the connection 2 to the spray discharge opening 6 through the main line 5. The liquid source supplies liquid to the main line 5. The high-pressure pump 3 is arranged in the main line 5. The high-pressure pump 3 pressurizes the liquid. The main line 5 has a suction chamber 9 and a pressure chamber 10. The high-pressure pump 3 is arranged between the suction chamber 9 and the pressure chamber 10 of the main line 5. The main line 5 has the suction chamber 9 between the connection 2 and the high-pressure pump 3. The main line 5 has the pressure chamber 10 between the high-pressure pump 3 and the spray discharge opening 6. In the embodiment, the suction chamber 9 is formed by a section of the main line 5 between the connection 2 and the high-pressure pump 3. In the embodiment, the pressure chamber 10 is formed by a section of the main line 5 between the high-pressure pump 3 and the spray discharge opening 6. The high-pressure pump 3 conveys liquid from the suction chamber 9 to the pressure chamber 10. A greater pressure prevails in the pressure chamber 10 than in the suction chamber 9, especially during the operation of the high-pressure pump 3. The suction chamber 9 and the pressure chamber 10 are components of the main line 5. Downstream of the high-pressure pump 3, a greater pressure prevails in the main line 5 than upstream of the high-pressure pump 3, during the operation of the high-pressure pump 3.

The high-pressure pump 3 is arranged in the pump unit 16. To drive the high-pressure pump 3, the pressure washer 1 has a motor 4. The motor 4 is arranged in the pump unit 16. The motor 4 may be configured as a brushless DC motor. A brushless DC motor is also referred to as an EC motor. The motor 4 may also be a universal motor. In the embodiment, the motor 4 is an induction motor. The induction motor in the embodiment is operated with AC voltage. For example, the voltage source can be provided by the mains voltage. If a battery or rechargeable battery operation is provided, the motor may also be a brushless DC motor. It may be provided that the rechargeable battery is part of the pressure washer 1.

The pressure washer 1 comprises a main line valve 8. The main line valve 8 is arranged in the main line 5. The main line valve 8 has two valve states. The two valve states comprise a closed state and an open state. In the open state, the main line valve 8 permits a throughflow of liquid through the main line 5. In the closed state, the main line valve 8 prevents a throughflow of liquid through the main line 5. In the open state of the main line valve 8, liquid is sprayed out of the spray discharge opening 6. In the closed state of the main line valve 8, no liquid is sprayed out of the spray discharge opening 6. In the embodiment, the main line valve 8 is arranged in the sprayer unit 11. In the embodiment, the main line valve 8 is arranged between the high-pressure pump 3 and the spray discharge opening 6.

The pressure washer 1 comprises a shut-off arrangement 7. The pressure washer 1 is configured such that, owing to the pressure present in the pressure chamber 10, the shut-off arrangement 7 causes the motor 4 to be in the off state when the pressure in the pressure chamber corresponds at least to a pressure threshold value.

The motor 4 has a switch 18. The switch 18 is used to switch the motor 4 between the on and the off state. The shut-off arrangement 7 has an actuating element 19. The pressure washer 1 is configured such that the liquid in the pressure chamber 10 acts on the actuating element 19 of the shut-off arrangement 7 in such a way that the actuating element 19 actuates the switch 18 of the motor 4 such that the motor 4 is in the off state if the pressure in the pressure chamber 10 corresponds at least to the pressure threshold value.

In FIG. 1, a pressure relief line 20 is shown. The pressure relief line 20 fluidically connects the pressure chamber 10 to the suction chamber 9. Via the pressure relief line 20, a further fluidic connection of suction chamber 9 and pressure chamber 10 is possible separately from the fluidic connection of the suction chamber 9 to the pressure chamber 10 via the high-pressure pump 3.

The pressure relief line 20 may be closed or open. A pressure relief valve 21 is arranged in the pressure relief line 20. The pressure relief valve 21 is configured such that it opens if the pressure in the pressure chamber 10 corresponds at least to the pressure threshold value.

The pressure washer 1 is configured such that there is a fluidic connection between the pressure chamber 10 and the suction chamber 9 if the pressure in the pressure chamber 10 corresponds at most to a starting pressure value. The starting pressure value is less than the pressure threshold value. In the embodiment, the pressure washer 1 has a return line 12. The return line 12 can fluidically connect the pressure chamber 10 to the suction chamber 9. Via the return line 12, a further fluidic connection of suction chamber 9 and pressure chamber 10 is possible separately from the fluidic connection of the suction chamber 9 to the pressure chamber 10 via the high-pressure pump 3 and separately from the pressure relief line 20.

The main line 5 has an output opening 15. Liquid can flow from the main line 5 into the return line 12 through the output opening 15. The output opening 15 is directly connected to the return line 12.

The pressure washer 1 comprises a start valve 22. The pressure washer 1 is configured such that, when a starting volume threshold value of the volume flow through the start valve 22 is reached or exceeded, the start valve 22 closes. In particular, when the starting volume threshold value of the volume flow through the start valve 22 is reached or exceeded, the pressure in the pressure chamber 10 corresponds at least to the starting pressure value. When the start valve 22 is closed, no liquid can flow from the pressure chamber 10 into the suction chamber 9 through the return line 12. As illustrated in FIG. 1, the start valve 22 is arranged in the main line 5. The start valve 22 is arranged in the main line 5 downstream of the high-pressure pump 3. The start valve 22 is arranged in the main line 5 upstream of the return line 12. Liquid conveyed by the high-pressure pump 3 first of all impinges upon the start valve 22 before it can penetrate the return line 12. The start valve 22 is arranged outside the return line 12.

The main line 5 is that line of the pressure washer 1 in the region between the high-pressure pump 3 and the spray discharge opening 6 in which the liquid travels the shortest distance from the high-pressure pump 3 to the spray discharge opening 6. Branchings off from the main line 5, in which liquid may possibly first of all penetrate the branch and then flow back again, are not part of the main line 5.

The pressure washer 1 is configured such that, during operation of the pressure washer 1, the liquid flows with a volume flow through the start valve 22 below the starting volume threshold value without the possibility of branching off from the high-pressure pump 3 to the start valve 22 in the main line 5. In particular, the liquid flows independently of the volume flow through the start valve 22 without the possibility of branching off from the high-pressure pump 3 to the start valve 22 in the main line 5 during operation of the pressure washer 1.

The start valve 22 essentially has three states. The states of the start valve 1 are determined by the value of the volume flow through the start valve 22. If the value of the volume flow of the liquid through the start valve 22 is less than a resting volume threshold value, the start valve 22 is in an inoperative mode. The inoperative mode of the start valve 22 is illustrated in FIG. 1. In the inoperative mode, the pressure exerted by the liquid on the start valve 22 is not sufficient to transfer the start valve 22 into another state. The start valve 22 has a valve member 27. The valve member 27 is preloaded into the inoperative position of the inoperative mode. It may be provided that the valve member 27 closes a valve seat of the main line in this case, such that a throughflow of liquid through the main line 5 is prevented by the valve member 27. In the embodiment, however, the start valve 22 has a stop element 17. In the inoperative position, the valve member 27 bears against the stop element 17. The valve member 27 is preloaded in the direction of the stop element 17. If the volume flow through the start valve 22 is less than the resting volume threshold value, the valve member 27 bears against the stop element 17. In particular, the valve member 27 bears against the stop element 17 when the valve member 27 is in a state in which it is not loaded by the liquid. In the embodiment, the start valve 22 is configured such that, in the inoperative mode, passage of liquid through the start valve 22 is possible. For this purpose, a gap is provided between the valve member 27 and the valve housing when the valve member 27 bears against the stop element 17.

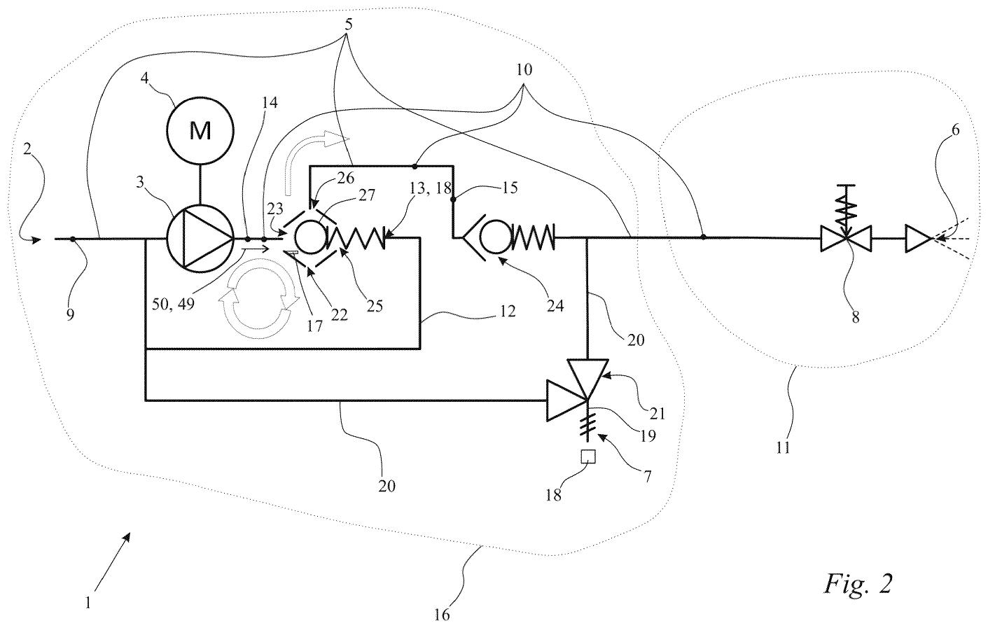

FIG. 2 shows the start valve 22 in a starting mode. In the starting mode, liquid is conveyed through the start valve 22 from the pressure chamber 10 of the main line 5 via the return line 12 back into the suction chamber 9. The value of the volume flow through the start valve 22 corresponds at least to the resting volume threshold value in the starting mode of the start valve 22. The value of the volume flow of the liquid through the start valve 22 is less than a starting volume threshold value in the starting mode. The starting volume threshold value is greater than the resting volume threshold value. In the embodiment, the start valve 22 is configured such that it permits the throughflow of liquid from the pressure chamber 10 into the return line 12 at a volume flow through the start valve 22 below the starting volume threshold value.

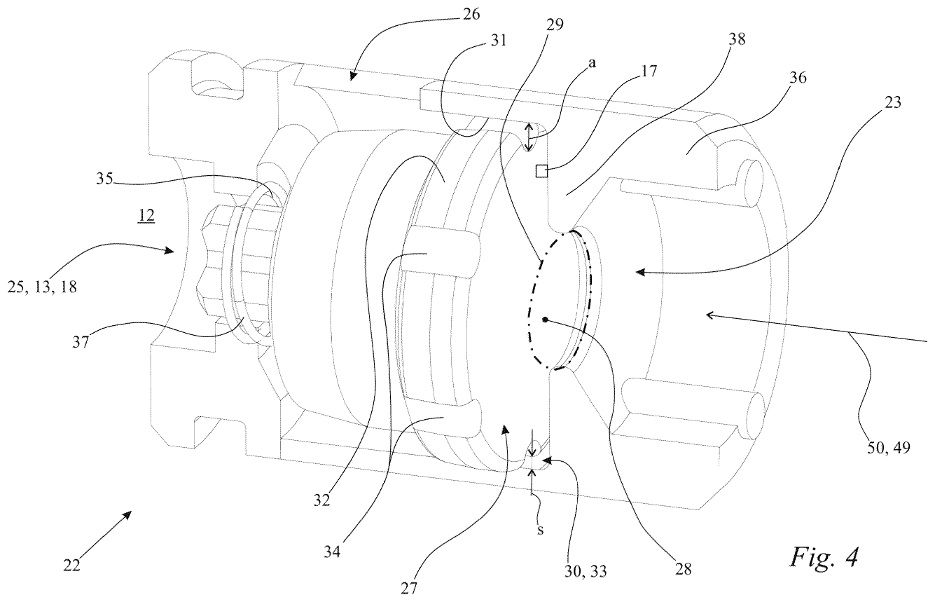

The start valve 22 has a valve seat 35 which is illustrated in FIG. 4. When the valve member 27 bears against the valve seat 35, a throughflow of liquid from the pressure chamber 10 of the main line 5 into the return line 12 is prevented. In the starting mode, the valve member 27 is in a position in which it does not bear either against the stop element 17 or against the valve seat 35.

The start valve 22 divides the pressure chamber 10 of the main line 5 into a pump section 14 and a spray discharge section 15. The pump section 14 of the pressure chamber 10 of the main line 5 extends from the high-pressure pump 2 to the start valve 22. The spray discharge section 15 of the pressure chamber 10 of the main line 5 extends from the start valve 22 to the spray discharge opening 6. In the starting mode of the start valve 22, liquid can flow through the start valve 22 both from the pump section 14 into the spray discharge section 15 and from the pump section 14 into the return line 12. The size of the volume flow that determines the position of the valve member 27 in the start valve 22 is almost unaffected by the partial branching of the volume flow into the return line 12 that only occurs downstream of the valve member 27. The size of the volume flow that determines the position of the valve member 27 in the start valve 22 is almost unaffected by the partial division of the volume flow, which occurs only downstream of the valve member 27, into a proportion of the volume flow that flows into the spray discharge section 15 and a further proportion of the volume flow that flows into the return line.

The start valve 22 has an inlet 23. The inlet 23 of the start valve 22 is connected to the main line 5. The inlet 23 of the start valve 22 is connected to the pump section 14 of the pressure chamber 10 of the main line 5. The start valve 22 has a return outlet 25. The return outlet 25 of the start valve 22 is connected to the return line 12. The start valve 22 has a main line outlet 26. The main line outlet 26 is connected to the main line 5. The main line outlet 26 is connected to the spray discharge section 15 of the pressure chamber 10 of the main line 5. The return line 12 has an inlet 13. The valve seat 35 of the start valve 22 is arranged at the inlet 13 of the return line 12. The inlet 13 of the return line 12 coincides with the return outlet 25 of the start valve 22. The valve seat 35 of the start valve 22 is arranged at the output opening 15 of the main line 5. The output opening 15 of the main line 5 coincides with the inlet 13 of the return line 12. In the embodiment, the return outlet 25 of the start valve 22 is the output opening 15 of the main line 5.

In the starting mode of the start valve 22, liquid can flow from the inlet 23 of the start valve 22 both to the return outlet 25 and to the main line outlet 26.

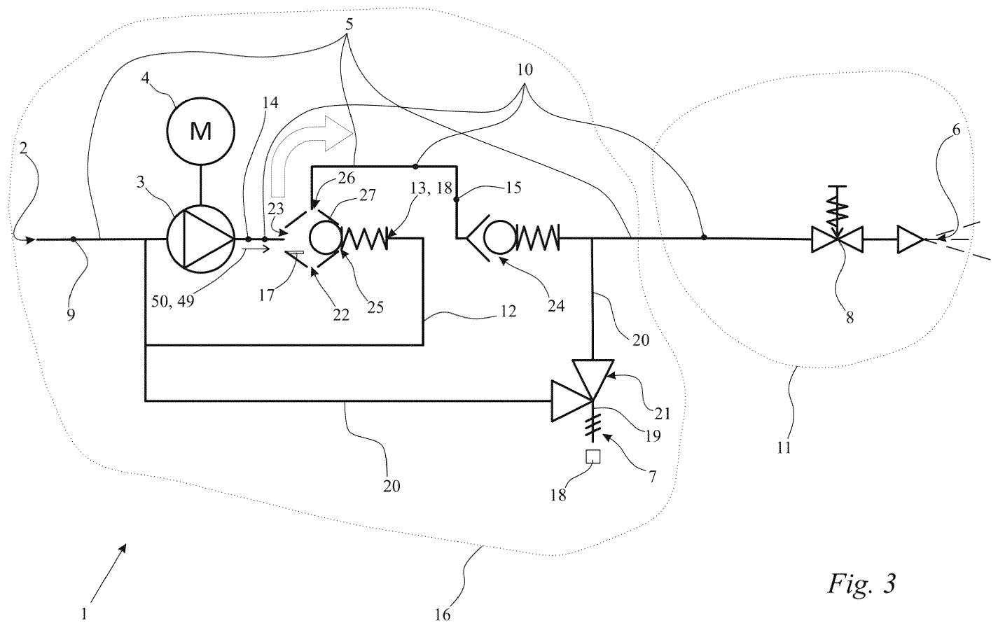

FIG. 3 shows the start valve 22 in a closing mode. The start valve 22 is configured such that it prevents the throughflow of liquid from the pressure chamber 10 into the return line 12 at a volume flow through the start valve 22 which corresponds at least to the starting volume threshold value. If the value of the volume flow through the start valve corresponds at least to the starting volume threshold value, the start valve 22 closes the return outlet 25.

The start valve 22 is configured such that it permits a direct throughflow of liquid from the pump section 14 into the spray discharge section 15 if the value of the volume flow through the start valve 22 corresponds at least to the starting volume threshold value. In particular, a loss-free throughflow of liquid from the pump section 14 into the spray discharge section 15 through the start valve 22 is possible in the closing mode. In the closing mode of the start valve 22, the liquid flows directly from the inlet 23 of the start valve 22 to the main line outlet 26 of the start valve 22. In the closing mode of the start valve 22, the liquid conveyed by the high-pressure pump 3 flows directly from the pump section 14 into the spray discharge section 15 without a detour via the return line 12. The closing mode of the start valve 22 is also referred to as the operating mode.

As illustrated in FIGS. 1 to 3, the pressure washer 1 comprises a check valve 24. The check valve 24 is arranged in the pressure chamber 10. The check valve 24 is arranged downstream of the high-pressure pump 3. The check valve 24 is arranged downstream of the start valve 22. The check valve 24 is arranged upstream of the shut-off arrangement 7 in the pressure chamber 10. The start valve 22 is arranged in the main line 5 between the high-pressure pump 3 and the check valve 24. As a result of the fact that the shut-off arrangement 7 is arranged between the check valve 24 and the main line valve 8, the pressure on the shut-off arrangement 7 can only rise and not fall as long as the motor 4 for driving the high-pressure pump 3 is running and the main line valve 8 is closed. This can also have the effect that the pressure on the pressure relief valve 21 can only rise as long as the motor 4 for driving the high-pressure pump 3 is running and the main line valve 8 is closed. This ensures that the pressure in the pressure chamber 10 exceeds the pressure threshold value and the shut-off arrangement 7 transfers the motor 4 into the off state. It can thus also be ensured that the pressure in the pressure chamber 10 exceeds the pressure threshold value and the pressure relief valve 21 opens.

FIG. 4 shows the valve 22 in a partially sectioned illustration. The start valve 22 has a valve housing 36. The valve member 27 is arranged in the valve housing 36. The valve member 27 is movable in the valve housing 36 in a movement direction 49. The liquid conveyed by the high-pressure pump 3 from the connection 2 to the spray discharge opening 6 through the main line 5 impinges upon the start valve 22, in particular on the valve member 27 of the start valve 22, in the main line 5 in a flow direction 50. The flow direction 50 is that direction in which the liquid flows into the start valve 22 through the inlet 23 of the start valve 22. The movement direction 49 of the valve member 27 runs in the direction of the flow direction 50. The movement direction 49 runs along a movement axis of the valve member 27. The movement direction 49 extends in the longitudinal direction of the start valve 22. The valve member 27 is movable in the flow direction 50 for closing the valve seat 35 of the start valve 22. Via a movement of the valve member 27 in the flow direction 50, the valve seat 35 arranged at the inlet 13 of the return line 12 can be closed.

The valve member 27 is preloaded in a direction away from the inlet 13 of the return line 12. The valve member 27 is preloaded counter to the movement direction 49. In the embodiment, a spring 37 preloads the valve member 27 in a direction away from the return line 12. The spring 37 is supported in the region of the valve seat 35 of the start valve 22. The spring 37 is arranged between the valve seat 35 and the valve member 27. The valve member 27 bears against the stop element 17, illustrated in FIG. 4, in the inoperative mode of the start valve 22. The stop element 17 limits a movement of the valve member 27 in a direction away from the return line 12. The stop element 17 limits a movement of the valve member 27 in a direction counter to the flow direction 50. The stop element 17 limits a movement of the valve member 27 in a direction counter to the movement direction 49.

The valve member 27 has an inflow surface 28 on its end face facing away from the return line 12. The inflow surface 28 is aligned transversely, in the embodiment perpendicularly, to the flow direction 50. The stop element 17 protrudes in the flow direction 50 over a base body 38 of the housing 36 of the start valve 22. The stop element 17 prevents a full-surface contact of the inflow surface 28 of the valve member 27 on the housing 36 of the start valve 22. As seen in the flow direction 50, the stop element 17 has an outer contour. The outer contour of the stop element 17 limits a stop surface running perpendicularly to the flow direction 50. The stop surface is only a fraction of the inflow surface 28. In the embodiment, the stop surface is formed by the surface of a plurality of stop elements. In the embodiment, the total stop surface is less than 20%, in particular less than 10%, of the inflow surface 28. A gap is formed between the base body 38 and the valve member 27 in the inoperative mode of the start valve 22. This is ensured by the stop element 17.

The start valve 22 has an inlet surface 29. The inlet surface 29 runs perpendicularly to the flow direction 50. The liquid enters the start valve 22 through the inlet surface 29. The liquid enters the interior of the housing 36 of the start valve 22 through the inlet surface 29. In the inoperative mode of the start valve 22, the valve member 27 permits a minimum free cross-sectional area 30 through the main line 5. The minimum free cross-sectional area 30 is the area which the start valve 22 always provides at least as a throughflow area for the liquid. In the inoperative mode of the start valve 22, the smallest throughflow area for the liquid in the start valve 22 corresponds to the minimum free cross-sectional area 30.

In the inoperative mode of the start valve 22, the valve member 27 is in a state in which it is not loaded by the liquid. In the inoperative mode, the minimum free cross-sectional area 30 is at least 5%, in the embodiment at least 10%, of the inlet surface 29. The minimum free cross-sectional area 30 is not more than 70%, in the embodiment not more than 60%, of the inlet surface 29.

The valve member 27 has a peripheral surface 32 facing an inner wall of the start valve 22. A gap 33 is formed between the peripheral surface 32 and the inner wall 31. The gap 33 forms the minimum free cross-sectional area 30.

As illustrated in FIG. 4, the peripheral surface 32 has a plurality of cutouts 34 distributed over the circumference. The cutouts 34 are depressions in the peripheral surface 32. The peripheral surface 32 has a smallest gap distance s, as measured perpendicularly to the inner wall 31, from the inner wall 31 of the start valve 22. The smallest gap distance s is measured in a direction radially with respect to the longitudinal axis of the start valve 22. The smallest gap distance s is measured in the embodiment in a direction radially with respect to the movement direction 49 of the valve member 27. The cutouts 34 have a largest gap distance a, as measured perpendicularly to the inner wall 31 of the start valve 22, from the inner wall 31 of the start valve 22. The largest gap distance a is measured in a direction radially with respect to the longitudinal axis of the start valve 22. The largest cutout distance a is measured radially with respect to the movement direction 49 of the valve member 27. The largest cutout distance a is at least twice the smallest gap distance s. It can also be provided that the largest cutout distance a is at least three times the smallest gap distance s. In the embodiment, the largest cutout distance a is at least four times the smallest gap distance s. The largest cutout distance a is at most 20 times the smallest gap distance s. The largest cutout distance a is at most 18 times, in the embodiment at most 16 times, the smallest gap distance s. At least two cutouts 34, in particular, at least four cutouts, in the embodiment six cutouts 34, are provided. The cutouts 34 are distributed in the circumferential direction around the movement direction 49 of the valve member 27, in particular uniformly, in the peripheral surface 32 of the valve member 27.

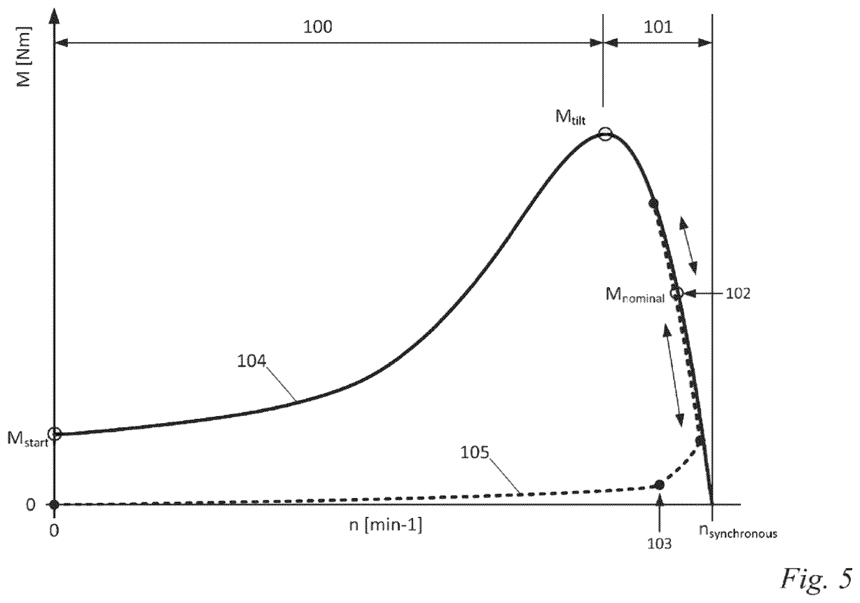

FIG. 5 shows the torque-rotational speed characteristic curve of an asynchronous motor. The rotational speed n is plotted on the x axis and the torque M is plotted on the y axis. The characteristic curve 104 is drawn with a solid line. The operating range 101 extends between a tilting frequency assigned to the tilting torque Mₜᵢₗₜ and the synchronous frequency n_{synchronous}. In order to arrive in the operating range, the asynchronous motor has to run up. The rotational speed range in which the run up takes place is indicated by the reference number 100. The corresponding rotational speed range is referred to as a run-up range 100. The run-up range 100 lies below the operating range 101. The run-up range 100 is directly adjacent to the operating range 101.

Owing to the start valve 22 according to the disclosure, only a small load is present during the run-up phase 100. The high-pressure pump 3 or the motor 4 does not have to work against a high pressure. The required torque against which the motor 4 works is shown with a dotted load line 105. The start valve 22 is initially in the inoperative mode when the motor 4 is switched on. This state of the start valve 22 is illustrated in FIG. 1. Owing to the volume flow then generated during the run-up phase 100, the valve member 27 moves away from the stop element 17 into the starting mode. This starting mode is illustrated in FIG. 2. The liquid conveyed by the pump 3 can flow from the pressure chamber 10 through the start valve 22 into the return line 12 and back into the suction chamber 9. A high torque is not required for this, as the load characteristic curve 105 in the region of the run-up phase 100 in FIG. 5 shows. The motor 4 can easily run through the run-up range 100 and reach a rotational speed in the operating range 101. Owing to the start valve according to the disclosure, it is ensured that the start valve only changes into the closing mode, illustrated in FIG. 3, when the rotational speed is in the operating range 101 of the motor 4 after the motor 4 has run up. Only then does the start valve 22 close so that liquid can no longer flow through the return line 12 from the pressure chamber 10 into the suction chamber 9. Subsequently, a much larger load is applied to the pump 3, as the steep rise of the load curve 105 in the operating range 101 in FIG. 5 also shows. The rotational speed can then adjust to the rotational speed at the operating point 102.

If the start valve 22 were already to close at a rotational speed outside the operating range 101—at a rotational speed in the run-up range 100—, the load curve would already rise steeply in a range below the tilting rotational speed, which is assigned to the tilting torque Mₜᵢₗₜ. The required torque, which is shown by the load curve 105, would exceed the available torque shown by the characteristic curve 104. The result would be overheating of the motor 4 and stalling of the motor 4. The rotational speed of the motor 4 would decrease and the available torque would also decrease, as can be gathered from the characteristic curve 104 to the left of the tilting rotational speed. At some point the motor 4 would stop.

The start valve 22 according to the disclosure reliably ensures that the start valve 22 switches only when the rotational speed n of the motor 4 is in the operating range 101.

The torque characteristic curve shown in FIG. 5 is that of an asynchronous motor. However, the description also applies analogously to other types of motor.

In particular, after the motor 4 is switched off by actuation of the switch 18 of the shut-off arrangement 7 shown in FIGS. 1 to 3, following closure of the main line valve 8 a large pressure prevails in the pressure chamber 10. This pressure is partially dissipated by opening of the pressure valve 21. Via this pressure dissipation, the start valve 22 opens such that a return flow of liquid from the pressure chamber 10, in particular from the pump section 14 of the pressure chamber 10, into the suction chamber 9 is possible. The start valve 22 is then either in the inoperative mode or in the starting mode. When the motor 4 is switched on again, the pump 3 has to operate against a much lower pressure because of the open start valve 22 than if the start valve 22 were not present. Owing to the arrangement of the start valve 22 in the main line 5, the volume flow, which causes switching of the start valve 22, is clearly defined.

It is understood that the foregoing description is that of the preferred embodiments of the invention and that various changes and modifications may be made thereto without departing from the spirit and scope of the invention as defined in the appended claims.

1. A pressure washer comprising:
a connection for a liquid source;
a high-pressure pump;
a main line, through which a liquid is conveyable from said connection to a spray discharge opening of said main line via said high-pressure pump;
said main line having a suction chamber between said connection and said high-pressure pump;
said main line having a pressure chamber between said high-pressure pump and said spray discharge opening;
said pressure chamber being fluidically connected to said suction chamber via a return line;
said main line having an outlet opening through which the liquid from said main line is configured to flow into said return line;
a start valve;
the pressure washer being configured such that said start valve closes so that no liquid can flow through said return line from said pressure chamber into said suction chamber if a volume flow through said start valve corresponds at least to a starting volume threshold value;
said start valve having a valve member;
wherein the liquid conveyed through said main line from said connection to said spray discharge opening via said high-pressure pump impinges on said start valve in said main line in a flow direction;
said start valve being arranged in said main line downstream of said high-pressure pump; and,
said start valve having a valve seat arranged at said outlet opening of said main line and configured to be closed by a movement of said valve member in the flow direction.

2. The pressure washer of claim 1, wherein said start valve is arranged in said main line upstream of said return line.

3. The pressure washer of claim 1, wherein said start valve is arranged outside said return line.

4. The pressure washer of claim 1, wherein the pressure washer is configured such that the liquid flows with the volume flow through said start valve below said starting volume threshold value without a possibility of branching off from said high-pressure pump to said start valve in said main line when the pressure washer is operated.

5. The pressure washer of claim 1, wherein the pressure washer is configured such that, during operation of the pressure washer, the liquid flows with the volume flow through said start valve below said starting volume threshold value independently of the volume flow through said start valve without a possibility of branching off from said high-pressure pump to said start valve in said main line.

6. The pressure washer of claim 1, wherein said start valve is configured such that said start valve permits the throughflow of liquid from said pressure chamber into said return line at the volume flow through said start valve below said starting volume threshold value.

7. The pressure washer of claim 6, wherein said start valve is configured such that said start valve prevents the throughflow of liquid from said pressure chamber into said return line if the volume flow through said start valve corresponds at least to said starting volume threshold value.

8. The pressure washer of claim 1, wherein said start valve divides said pressure chamber of said main line into a pump section and a spray discharge section; said pump section is arranged between said high-pressure pump and said start valve; said spray discharge section is arranged between said start valve and said spray discharge opening; and, said start valve is configured such that said start valve allows a direct throughflow of the liquid from said pump section into said spray discharge section when said volume flow through said start valve corresponds at least to said starting volume threshold value.

9. The pressure washer of claim 1, wherein said start valve has an inlet connected to said main line; said start valve has a return outlet connected to said return line; and, said start valve has a main line outlet connected to said main line.

10. The pressure washer of claim 9, wherein said start valve is configured to close said return outlet if said volume flow through said start valve corresponds at least to said starting volume threshold value.

11. The pressure washer of claim 1, wherein said valve member is movable in a movement direction running in a direction of said flow direction.

12. The pressure washer of claim 1 further comprising:
a stop element for said valve member;
said valve member being preloaded in a direction of said stop element; and,
said valve member being configured to bear against said stop element when said volume flow through said start valve falls below a resting volume threshold value.

13. The pressure washer of claim 12, wherein said valve member is configured to bear against said stop element when the volume flow through said start valve falls below a resting volume threshold value in a state of said valve member unloaded by the liquid.

14. The pressure washer of claim 1, wherein said start valve has an inlet surface perpendicular to the flow direction, through which the liquid enters said start valve; in a state unloaded by the liquid, said valve member permits a minimum free cross-sectional area through said main line; and, said minimum free cross-sectional area is at least 5% of said inlet surface.

15. The pressure washer of claim 14, wherein said minimum free cross-sectional area is at least 10% of said inlet surface.

16. The pressure washer of claim 14 further comprising:
a stop element for said valve member;
said valve member being preloaded in a direction of said stop element;
said valve member being configured to bear against said stop element when said volume flow through said start valve falls below a resting volume threshold value;
said valve member having a peripheral surface pointing to an inner wall of said start valve; and,
a gap forming said minimum free cross-sectional area being formed between said peripheral surface and said inner wall.

17. The pressure washer of claim 16, wherein said peripheral surface has a plurality of cutouts distributed over a circumference thereof; said peripheral surface has a smallest gap distance, as measured perpendicularly to said inner wall of said start valve, from said inner wall of said start valve; said cutouts have a largest cutout distance, as measured perpendicularly to said inner wall of said start valve, from said inner wall of said start valve; and, said largest cutout distance is at least twice said smallest gap distance.

18. The pressure washer of claim 17, wherein said largest cutout distance is at most 20 times the smallest gap distance.

19. The pressure washer of claim 1, wherein said valve seat is arranged at an inlet of said return line.
